(19) United States
(12) Patent Application Publication
(10) Pub. No.: US 2023/0282127 A1
(43) Pub. Date: Sep. 7, 2023

(54) APPARATUS, AND RELATED SYSTEMS AND METHODS

(71) Applicant: Creative Kids Far East, Inc., Chestnut Ridge, NY (US)

(72) Inventor: Daniel DeLapa, Pomona, NY (US)

(21) Appl. No.: 18/049,218

(22) Filed: Oct. 24, 2022

Related U.S. Application Data
(63) Continuation of application No. PCT/US22/18751, filed on Mar. 3, 2022.

(51) Int. Cl. G09B 5/06; G09B 1/16; G09B 19/04; G09B 1/06

(52) U.S. Cl. CPC G09B 5/062; G09B 1/16; G09B 19/04; G09B 1/06

(57) ABSTRACT

An apparatus for assisting an education includes a housing, at least two receptacles, at least two electrical circuits, and a controller. The housing includes a surface and an interior. The at least two receptacles are disposed on the surface of the housing. And, each receptacle is configured to identify an idea, each idea being related to the other idea identified by the other receptacle. Each of the at least two electrical circuits includes a set of leads disposed in a respective one of the at least two receptacles. Each of the set of leads is operable to dose (complete) the respective circuit when electrically conductive modeling compound is inserted into the receptacle and contacts both leads. The controller is disposed in the housing's interior and coupled with the at least two electrical circuits. The controller also performs a function in response to the closure of one or more of the electrical circuits.

### BACKGROUND

Many people love playing with modeling compound, such as Play-Doh, because forming it into any desired shape encourages creativity and imagination, and exercises their sense of touch and use of their hands. Many parents of people love it when the people play with an interactive board that includes concepts that people need to learn, such as the alphabet, numbers, and/or simple words that identify common things, such as dogs and cats. These interactive boards typically involve a picture of the concept, such as a letter, a number, or a word, on or adjacent a button. When the person pushes the button, the interactive board says the letter, number or thing associated with that button. In this manner, the person learns how to identify the letter visually and aurally.

Thus, there is a need for an apparatus that combines these two popular mechanisms for playing and learning.

### SUMMARY

In one aspect of the invention, an apparatus for assisting an education includes a housing having a surface and an interior; at least two receptacles disposed on the surface of the housing, at least two electrical circuits, and a controller disposed in the housing's interior and coupled with the at least two electrical circuits. Each receptacle is configured to identify an idea, and each idea is related to the other idea identified by the other receptacle. For example, the idea identified by each of the at least two receptacles could be a letter of the English alphabet, a number, and/or an animal that lives in Africa. Each of the at least two electrical circuits includes a set of leads disposed in a respective one of the at least two receptacles and each of the set of leads is operable to close the respective circuit when electrically conductive modeling compound is inserted into the receptacle and contacts both leads. In response to the closure of one or more of the electrical circuits, the controller performs a function, such as generating a sound that mimics a person saying the idea identified by the receptacle that corresponds with the closed electrical circuit. For example, the sound generated could mimic a person saying the letter, and/or number that corresponds with the receptacle, or mimic the sound made by the animal that corresponds with the receptacle.

With the ability to insert electrically conductive modeling compound into a receptacle of the apparatus, a person can use his/her hands and imagination while playing with the apparatus. And with the ability to generate aural and/or visual feedback when the electrically conductive modeling compound contacts the leads in the receptacle, a person can learn necessary concepts in such a way that he/she is more engaged. This helps the person retain the idea just learned, and have a deeper understanding of the idea. This is especially true when the receptacle is configured to form a 3-dimensional display of the idea in the electrically conductive modeling compound, that a person can view when the person withdraws the modeling compound from the receptacle. For example, the receptacle may be configured to identify the letter “A” by including a relief of an apple in the bottom of the receptacle. When the person inserts electrically conductive modeling compound into the receptacle, the controller generates a sound that mimics a person saying “A is for Apple”, and when the person withdraws the modeling compound from the receptacle the person includes a 3-dimensional display of an apple. Thus, the person is more engaged when learning the letter “A”, how to say it, and how it's used.

In another aspect of the invention, a method for assisting an education includes: 1) inserting electrically conductive modeling compound into a receptacle of a group of at least two receptacles, each of the at least two receptacles configured to identify an idea, each idea being related to the other idea identified by the other receptacle, 2) coupling, with the electrically conductive modeling compound, a set of leads disposed in a respective one of the at least two receptacles, each set of leads being included in a respective one of at least two electrical circuits, wherein when the set of leads is coupled with the electrically conductive modeling compound, the electrical circuit that includes the set of leads closes, and 3) performing, with a controller, a function in response to the closing of the electrical circuit.

### BRIEF DESCRIPTION OF THE DRAWINGS

FIG. 1 shows a perspective view of an apparatus, according to an embodiment of the invention.

FIG. 2 shows an exploded view of a portion of the apparatus shown in FIG. 1, according to an embodiment of the invention.

FIG. 3 shows a view of a portion of the apparatus shown in FIG. 1, according to an embodiment of the invention.

### DETAILED DESCRIPTION

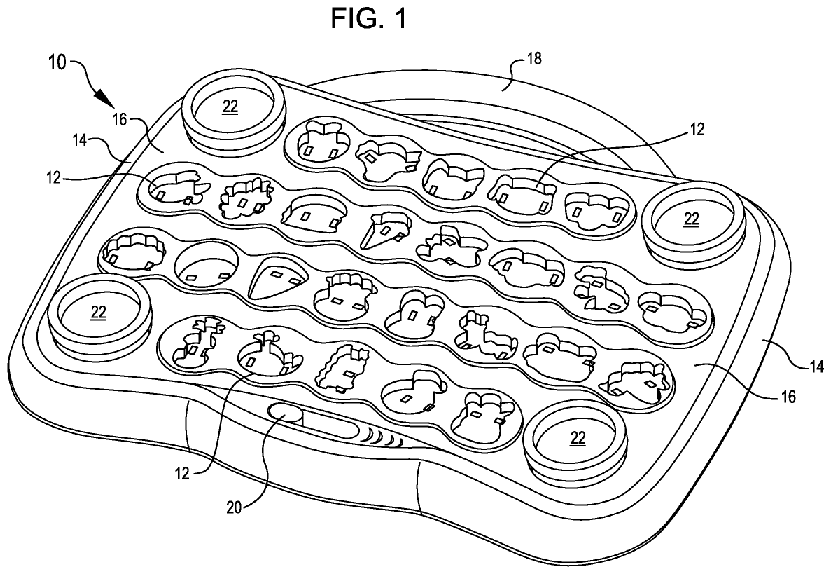

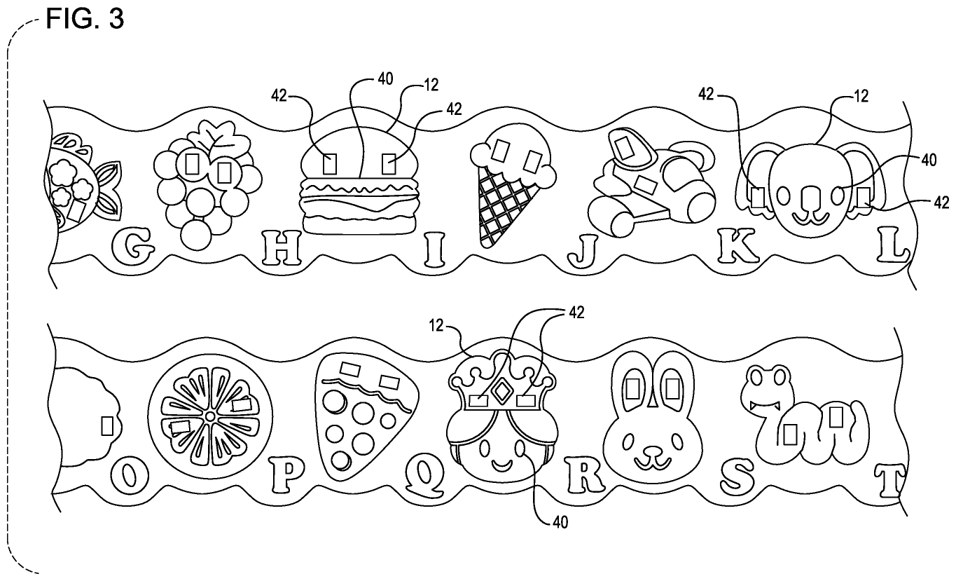

FIG. 1 shows a perspective view of an apparatus 10, according to an embodiment of the invention. Here, the apparatus 10 is a toy that a person can play with. In other embodiments, the apparatus 10 may be a tool or some other kind of device for assisting an education. The apparatus 10 includes at least two receptacles 12 (here twenty-six, only three labeled for clarity). As shown and discussed in greater detail in conjunction with FIG. 3, each of the receptacles 12 is configured to identify an idea that is related to the other ideas represented by the other receptacles 12. Here, for example, each of the ideas represented by a respective one of the receptacles 12 is a letter of the English alphabet. The concept unifying the receptacles 12 is the whole alphabet, and the ideas included in the concept are the individual letters of the alphabet. In other embodiments of the apparatus 10, the unifying concept may be the decimal (base 10) number system and the ideas included in the concept may be the individual numbers 1-10. In still other embodiments of the apparatus 10, the concept may be wild animals living in a region, such as Africa, and the ideas included in the concept may be some of the individual animals.

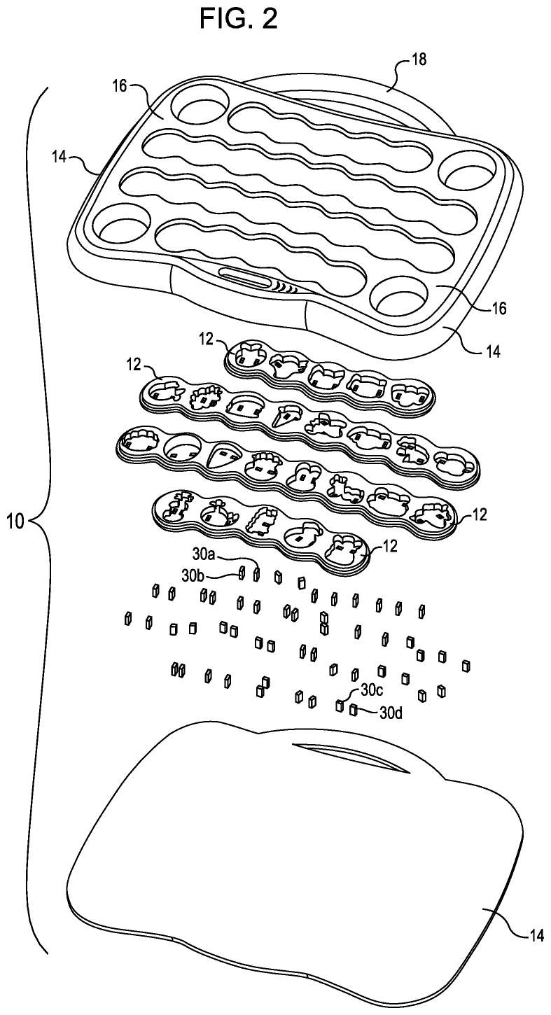

The apparatus 10 also includes at least two electrical circuits (not shown), each of which includes a set of leads (here two) that are disposed in a respective one of the receptacles 12. The leads are discussed in greater detail in conjunction with FIGS. 2 and 3. When electrically conductive modeling compound (not shown) is inserted into a receptacle 12 and contacts both leads disposed in the receptacle 12, an electrical circuit associated with the receptacle 12 and the idea corresponding with the receptacle 12 is closed—i.e., electricity may flow through the circuit. In this and other embodiments, the electrically conductive modeling compound is electrically conductive modeling clay. In other embodiments, the modeling compound may be electrically conductive Play Doh® or any other modeling compound that is electrically conductive. Each of the at least two electrical circuits is coupled with a controller (also not shown) that performs a function in response to one or more of the circuits closing. Here, for example, one of the receptacles 12 is configured to identify the letter “A”. When the person inserts electrically conductive modeling compound into the receptacle 12, the controller generates a sound that mimics a person saying “A”.

With the ability to insert electrically conductive modeling compound into a receptacle of the apparatus 10, a person can use his/her hands and imagination while playing with the apparatus 10. And with the ability to generate aural and/or visual feedback when the electrically conductive modeling compound contacts the leads in the receptacle 12, a person can learn necessary concepts in such a way that he/she is more engaged. This helps the person retain the idea just learned, and have a deeper understanding of the idea and concept.

Still referring to FIG. 1, the function that the controller performs in response to an electrical circuit closing may be any desired function that promotes the learning of the idea and/or concept and that engages the person. For example, in this and other embodiments, the controller instructs a speaker (not shown) to generate a sound that mimics a person saying the letter associated with the respective one of the receptacles 12 and then saying what the object is called that the receptacle 12 forms in the electrically conductive modeling compound when the modeling compound is inserted into the receptacle 12, For example, here, when electrically conductive modeling compound is inserted into the receptacle 12 that represents the letter “A”, the controller instructs a speaker to generate a sound that mimics a person saying “A is for Apple”. In other embodiments, the controller may instruct a speaker to mimic an animal making a sound, such as a lion roaring and/or a gorilla thumping his chest. In still other embodiments, the controller may provide a visual display, such as a flashing light, in response to an electrical circuit closing. The controller may also provide a display that combines aural and visual aspects.

Still referring to FIG. 1, the apparatus 10 may be configured as desired to provide the playing and learning functions. For example, in this and other embodiments, the apparatus 10 includes a housing 14 having a surface 16 and an interior (not shown). More specifically, the housing 14 is configured such that its shape is similar to a thick plate. In this configuration, each of the receptacles 12 may be located on the surface 16 which is located on a single side of the housing 14, and the electrical circuits may be disposed inside the housing, or the housing's interior. In other embodiments, some receptacles 12 may be located on one side of the housing 14, and some other receptacles 12 may be located on a different side of the housing 14. In addition, the housing may be made of any desired material. For example, in this and other embodiments, the housing may be made of plastic to help keep the weight of the apparatus 10 low. In other embodiments, the housing 14 may be made of metal, such a steel, to provide the apparatus 10 long-lasting durability.

The apparatus 10 also includes a handle 18 to allow a person to easily hold onto the apparatus 10 when in use or when the apparatus 10 is being carried to different location. In addition, the apparatus 10 includes a switch 20 to energize (turn on) the circuits disposed inside the apparatus's housing. When the electric circuits are energized, contacting a set of leads in a respective one of the receptacles 12 with electrically conductive modeling compound will cause the controller to perform its associated function. When the electrical circuits are not energized—i.e. the apparatus 10 is turned off—then contacting a set of leads in a respective one of the receptacles 12 with electrically conductive modeling compound will not cause the controller to perform its associated function. The apparatus 10 also includes a holder 22 (here four) in which a person can store electrically conductive modeling compound when the modeling compound is not being used.

FIG. 2 shows an exploded view of a portion of the apparatus 10 shown in FIG. 1, according to an embodiment of the invention. As previously mentioned, each of the at least two electrical circuits (not shown) includes a set of leads 30 (only two labeled for clarity).

The leads 30 may be configured as desired. For example, in this and other embodiments, each set of leads 30 includes two leads 30a and 30b for the receptacle 12 representing the letter “A”, or 30c and 30d for the receptacle 12 representing the letter “Z”. Each of these leads 30a, 30b, 30c, and 30d is an access point for a single electrical circuit that is associated with a respective one of the receptacles 12, and thus associated with the idea represented by the respective receptacle 12. For example, one of the set of leads 30a and 30b is disposed in the receptacle 12 that represents the letter “A”. The electrical circuit that these two leads 30a and 30b allow access to is unique to the receptacle 12. When the apparatus 10 is turned on, the electrical circuit that includes the leads 30a and 30b is energized. Electricity does not yet flow through the circuit, though, because the distance in air between the leads 30a and 30b is great enough to prevent electricity from jumping from the lead 30a to the lead 30b. In this state the electrical circuit is open. However, when electrically conductive modeling compound contacts both leads 30a and 30b, the modeling compound electrically bridges the gap between the leads 30a and 30b and closes the electrical circuit. Electricity then flows through the circuit signaling the controller to perform its function.

Other embodiments are possible. For example, one or more sets of the leads 30 may include more than two leads 30a and 30b, or 30c and 30d disposed in a respective one of the receptacles. This may be desirable to allow two or more electrical circuits to be associated with a respective receptacle 12 and thus allow two or more functions to be independently triggered when electrically conductive modeling compound is inserted into the receptacle.

FIG. 3 shows a view of a portion of the apparatus 10 shown in FIG. 1, according to an embodiment of the invention. As previously mentioned, the apparatus 10 includes at least two receptacles 12, each receptacle 12 configured to identify an idea related to the idea of another receptacle 12.

Each receptacle 12 may be configured as desired to identify an idea. For example, in this and other embodiments, each receptacle 12 (only three labeled for clarity) includes a perimeter that is shaped to look like the idea identified by the receptacle 12 and configured to extend into the interior of the apparatus's housing 14 (FIGS. 1 and 2). For example, the receptacle 12 that identifies the letter “H” includes a perimeter that is shaped like a hamburger, and extends below the housing's surface 16 (FIGS. 1 and 2). In this manner, the opening of the receptacle 12 is flush or close to flush with the housing's surface 16 (FIGS. 1 and 2), which makes it easier for a person to insert electrically conductive modeling compound into, and also makes it easier to carry and store the apparatus 10 when not in use because there are not many edges or lips protruding away from the surface 16 that can catch or snag nearby items. Moreover, each receptacle 12 includes a surface 40 (only three labeled for clarity) that is shaped to provide a 3-dimensional, visual display that a person can view before inserting electrically conductive modeling compound into the receptacle, and that generates a corresponding 3-dimensional, visual display in the modeling compound that is inserted into the receptacle 12. The surface 40 also includes a port 42 (only six labeled for clarity) for each lead (e.g. 30a, 30b, 30c and 30d in FIG. 2) to extend through and into a respective one of the receptacles 12. After a person removes the modeling compound from the receptacle 12, the person can look at the modeling compound and see the 3-dimensional, visual display that corresponds with the receptacle. With the 3-dimensional, visual display copied in the modeling compound, the idea identified by the receptacle 12 is reinforced when the person looks at the modeling compound.

The surface 40 of each receptacle 12 may be configured as desired to provide the 3-dimensional, visual display. For example, in this and other embodiments, the surface 40 is confined to the bottom of the receptacle 12; the surface 40 is not included in the perimeter of the receptacle 12. In addition, the surface 40 includes the 3-dimensional, visual display in relief—i.e. protruding out of the surface 40 and toward the housing's surface 16. In other embodiments the surface 40 includes the 3-dimensional, visual display in intaglio or counter-relief—i.e. protruding into the surface 40 and away from the housing's surface 16. In either configuration, the 3-dimensional, visual display generated in the modeling compound inserted into the receptacle 12 can be easily perceived and felt by a person after withdrawing the modeling compound from the receptacle 12.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An apparatus for assisting an education, the apparatus comprising:
a housing having a surface and an interior;
at least two receptacles disposed on the surface of the housing, each receptacle configured to identify an idea, each idea being related to the other idea identified by the other receptacle;
at least two electrical circuits, each of which includes a set of leads disposed in a respective one of the at least two receptacles and is operable to close the respective circuit when electrically conductive modeling compound is inserted into the receptacle and contacts both leads,
a controller disposed in the housing's interior and coupled with the at least two electrical circuits, the controller operable to perform a function in response to the closure of one or more of the electrical circuits.

2. The apparatus of claim 1 wherein the idea identified by each of the at least two receptacles is a letter of the English alphabet.

3. The apparatus of claim 1 wherein the idea identified by each of the at least two receptacles is a number.

4. The apparatus of claim 1 wherein the idea identified by each of the at east two receptacles is an animal that lives in Africa.

5. The apparatus of claim 2 wherein the function that the controller performs in response to the closure of one or more of the electrical circuits includes generating a sound that mimics a person saying the letter that is the idea identified by the receptacle that corresponds with the closed electrical circuit.

6. The apparatus of claim 3 wherein the function that the controller performs in response to the closure of one or more of the electrical circuits includes generating a sound that mimics a person saying the number that is the idea identified by the receptacle that corresponds with the closed electrical circuit

7. The apparatus of claim 4 wherein the function that the controller performs in response to the closure of one or more of the electrical circuits includes generating a sound that mimics a sound from the animal that is the idea identified by the receptacle that corresponds with the dosed electrical circuit.

8. The apparatus of claim 1 wherein the receptacle extends into the interior of the housing.

9. The apparatus of claim 1 wherein the receptacle includes a surface that is configured to visually display a representation of the idea identified by the receptacle.

10. The apparatus of claim 9 wherein the surface includes a 3-dimensional relief that represents the idea identified by the receptacle.

11. The apparatus of claim 1 wherein:
the idea identified by each of the at least two receptacles is a letter of the English alphabet,
the function that the controller performs in response to the closure of one or more of the electrical circuits includes generating a sound that mimics a person saying the letter that is the idea identified by the receptacle that corresponds with the closed electrical circuit, and
each of the at least two receptacles includes a surface having a 3-dimensional relief of an object that is identified in the English language by a word whose spelling begins with the English letter that is the idea identified by the respective receptacle.

12. The apparatus of claim 1 wherein the electrically conductive modeling compound includes modeling clay.

13. A method for assisting an education, the method comprising:
inserting electrically conductive modeling compound into a receptacle of a group of at least two receptacles, each of the at least two receptacles configured to identify an idea, each idea being related to the other idea identified by the other receptacle;
coupling, with the electrically conductive modeling compound, a set of leads disposed in a respective one of the at least two receptacles, each set of leads being included in a respective one of at least two electrical circuits, wherein when the set of leads is coupled with the electrically conductive modeling compound, the electrical circuit that includes the set of leads closes;
performing, with a controller, a function in response to the closing of the electrical circuit.

14. The method of claim 13 wherein:
the idea identified by each of the at least two receptacles is a letter of the English alphabet, and
performing, with a controller, a function in response to the closing of the electrical circuit includes generating a sound that mimics a person saying the letter that is the idea identified by the receptacle that received the electrically conductive modeling compound.

15. The method of claim 13 wherein:
the idea identified by each of the at least two receptacles is a number, and
performing, with a controller, a function in response to the closing of the electrical circuit includes generating a sound that mimics a person saying the number that is the idea identified by the receptacle that received the electrically conductive modeling compound.

16. The method of claim 13 wherein:
the idea identified by each of the at least two receptacles is an animal that lives in Africa, and
performing, with a controller, a function in response to the closing of the electrical circuit includes generating a sound that mimics a sound from the animal that is the idea identified by the receptacle that received the electrically conductive modeling compound.

17. The method of claim 13 wherein inserting electrically conductive modeling compound into a receptacle of a group of at least two receptacles includes filling the whole receptacle with the electrically conductive modeling compound.

18. The method of claim 13 wherein inserting electrically conductive modeling compound into a receptacle of a group of at least two receptacles includes forming a 3-dimension, intaglio or counter-relief, display in a portion of the electrically conductive modeling compound that contacts a surface of the receptacle.

19. The method of claim 13 wherein performing, with a controller, a function in response to the closing of the electrical circuit includes generating light.
